(19) United States
(12) Patent Application Publication
(10) Pub. No.: US 2011/0000779 A1
(43) Pub. Date: Jan. 6, 2011

(54) METHOD AND DEVICE FOR TREATMENT OF FLUID STREAMS THAT OCCUR DURING GASIFICATION

(75) Inventor: Johannes Kowoll, Bochum (DE)

Correspondence Address: COLLARD & ROE, P.C., 1077 NORTHERN BOULEVARD, ROSLYN, NY, 11576, US

(73) Assignee: UHDE GMBH, Dortmund (DE)

(21) Appl. No.: 12/735,937

(22) PCT Filed: Feb. 27, 2009
(86) PCT No.: PCT/EP2009/001397

§ 371 Date: Aug. 26, 2010

(30) Foreign Application Priority Data
Mar. 6, 2008 (DE) 10 2008 012 965.8

(51) Int. Cl. B01D 3/34

(52) U.S. Cl. 203/31; 202/158

(57) ABSTRACT

A method and a device for treating fluid streams produced during the combustion of carbon- and ash-containing fuels optimally uses the heat content contained in the system, as well as the amount of water for cooling and condensation required during recirculation of the latter. Suspension withdrawn from the mixing vessel is expanded in at least one subsequent stage during the evaporation of at least part of the water and reduction of the temperature, The vapor produced is cooled by direct contact with water and at least partially condensed out. In the device, a line between a lower section of the mixing vessel leads to a first expansion vessel that is designed as a scrubber tower, the scrubber tower being provided with a condensate collection bottom and a recirculation line towards the mixing vessel for the forming condensate, which mixing vessel is equipped with spray heads.

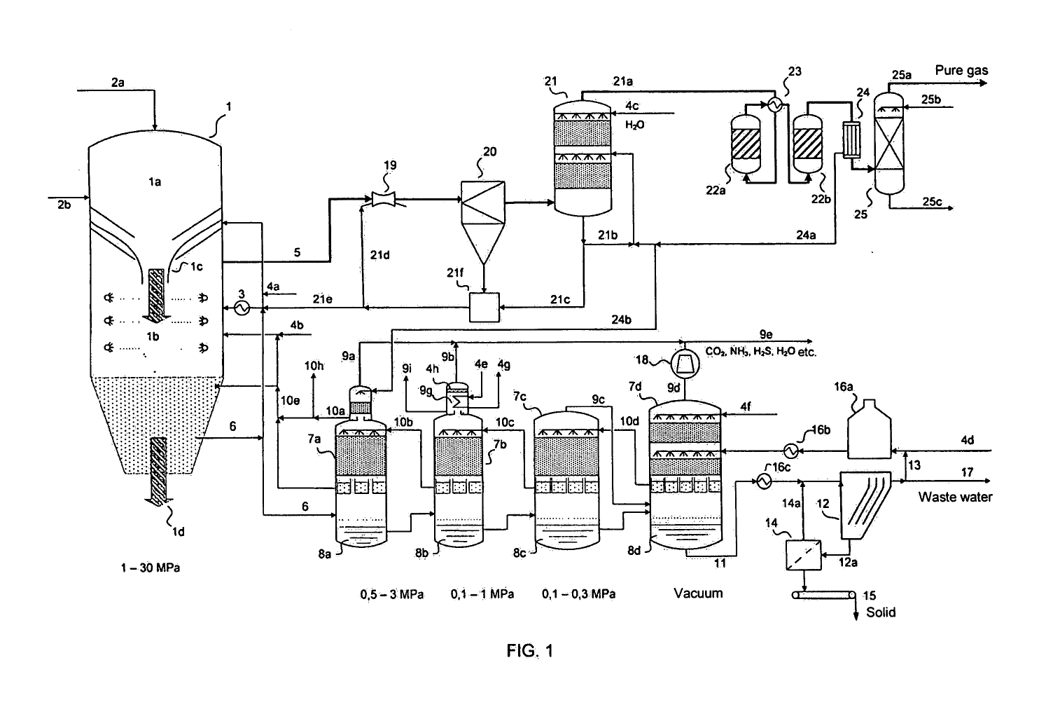

The invention is directed at a method for treatment of fluid streams that occur in the gasification of fuels that contain carbon and ash, of the type indicated in the preamble of claim 1, and to a device for implementing the method.

The production of a raw gas that contains hydrogen and carbon monoxide, from fuels that contain carbon, generally takes place by means of gasification with a gas that contains oxygen, at elevated temperature. The fuel is reacted with the gas in a reactor that is suitable for this purpose, whereby aside from the raw gas, a solid or liquefied byproduct is obtained, which generally consists of flue ash and liquefied slag and non-gasified fuel. The raw gas contains not only the main components of carbon monoxide and hydrogen, but also other gases and vapors, such as carbon dioxide, steam, sulfur compounds, nitrogen compounds, and chlorine compounds, most of which have to be removed from the gas.

Dust removal from and purification of the raw gas generally take place at clearly lower temperatures than gasification. Therefore, the raw gas is first cooled by means of indirect heat exchange, or by means of being mixed with a colder medium. Frequently, the raw gas is mixed with water, which evaporates completely or partially, thereby increasing the water content of the gas. If more water is fed into the raw gas than evaporates, the non-evaporated water is partly precipitated together with the solids that are contained in the raw gas, and separately transported out of the mixing region as a suspension. The solid suspension also contains dissolved gases and water-soluble substances that are formed during the gasification process, for example HCl, NH₃, or during neutralization of the acids with a base, for example NaCl.

The cooled raw gas also contains a smaller amount of dust types that generally have to be removed from the process for subsequent use. This can be done by means of washing and filtration processes. Afterwards, the raw gas is frequently subjected to an acid gas wash, during which the acidic gases are removed from the system. If the raw gas is needed for the production of hydrogen or a hydrogen-free gas, conversion of the carbon monoxide to carbon dioxide with subsequent separation of the carbon dioxide is generally carried out.

The precipitated suspension formed from the non-evaporated water and the solids washed out of the raw gas, which is precipitated in the mixing container, must be passed away once a specific solids concentration, for example a proportion of 5% by weight, has been reached, in order to prevent sedimentation of the solids.

Solids are supposed to be precipitated from the suspension that has been passed away. However, the suspension is hot, for example at 200° C., and is under high pressure, for example 3 MPa. Removal of the solids under these conditions would be very difficult, and therefore the suspension is generally first relaxed and cooled, and only then are the solids precipitated. In order to precipitate the fine particles that are in suspension, the water is generally passed into clarification or settling basins, whereby a low temperature, for example 50° C., is advantageous for efficient and cost-advantageous precipitation.

During cooling of the suspension, a predominant part of the heat and pressure energy is lost, without being used. The water that is obtained from precipitation, which is low in solids, is usually recirculated into the mixing container, to be mixed with raw gas. It is advantageous to reheat the water that is being recirculated before feeding it into the mixing container, and to use the heat from cooling the suspension in this connection. However, heating the water in a heat exchanger leads to intensive formation of deposits on the heat-exchanging surfaces, because the suspension and the water that is recirculated contain numerous substances washed out of the raw gas and the flue ash.

A method of procedure of this type can be derived from EP 0 648 828 B (=DE 694 05 841-T2), whereby there, the synthesis gas or raw gas is passed to a washing container, and then passes through other treatment steps, while the suspension is passed to a flash drum. Methods and systems for the gasification of fuels that contain carbon can be derived from U.S. Pat. No. 4,074,981 or U.S. Pat. No. 5,345,756, but these contain few indications as to how the suspension that forms in the mixing container, in each instance, is to be treated further.

A method for recycling of solids that contain carbon and are burdened with halogens is known from DE 41 09 231 C; these solids are conveyed into a reactor in a flow-capable state. The gas produced is quenched with alkaline water, in order to cool the gas and to wash out soot and alkalis. A method and a device for treatment of waste water from a synthesis gas washing system by means of vacuum flash and for recovery of steam is known from DE 698 31 867 T. Relaxation and heat recovery are hardly possible in this method, due to the low temperatures, whereby the condensate passed to the quench is also not preheated.

It is the task of the invention to indicate a method and a device with which the heat contents contained in the system can be optimally used, as can the amounts of water that are needed for cooling and condensation, whereby the latter are supposed to be recirculated.

This task is accomplished, according to the invention, with a method of the type indicated initially, in that the suspension passed out of the mixing container is relaxed in at least one subsequent stage, with evaporation of at least part of the water and a decrease in temperature, and that the resulting steam is cooled by means of direct contact with water, and condensed out, at least in part.

By means of the treatment of the suspension of dust and soot from gasification and water from a water quench, for example, according to the invention, the method of procedure according to the invention can be used for gasification of dried coal, coal mash, liquid fuels, for example refinery residues, and the like.

By means of the direct contact with water, the steam that forms during relaxation can be cooled directly and condensed, so that this condensate can be reused, in each instance.

For this purpose, the invention also provides, in an embodiment, that the resulting condensate from the first relaxation stage is recirculated to the mixing container, to be applied to the gases and slags that come from the reaction chamber, whereby the use of multiple relaxation stages can also be provided, that the suspension is passed from one relaxation stage to the subsequent relaxation stage, whereby the condensate of the further relaxation stage is recirculated into the preceding relaxation stage.

It is practical if a vacuum (0.02 MPa) is produced in the last relaxation stage, something that can be achieved, for example, in that cold fresh water is fed in. In this connection, in another embodiment of the invention, it can also be provided that the waste gases that form in the dome of the relaxation stage, in each instance, are drawn off and passed to further treatment.

In another embodiment of the method of procedure according to the invention, it is provided that the suspension is passed from the last relaxation stage to a settling basin or the like, for separation of solids and waste water, whereby the resulting waste water is recirculated into a relaxation stage.

A particular advantage of the invention consists, among other things, in that a partial stream of the suspension is recirculated to form a film of water in a transition location between reaction chamber and mixing container, whereby this recirculation of at least part of the suspension into the reaction chamber results in an optimal regulation possibility of the circulated mass streams.

In another embodiment, acidification of the suspension and/or of the water to be heated before or in the relaxation stages is provided, something that can be done with hydrochloric acid or acetic acid, for example. CO₂ escapes during relaxation of the suspension, due to the reduction in pressure, and during heating of the recirculated water, due to the reduction in solubility of the gases. Because of the escape of CO₂, the suspension becomes basic, and therefore Ca and Mg deposits, for example, are formed. In order to prevent this, according to the invention acid is metered in, in order to adjust a pH<7, for example 5 to 6, so that such deposit-forming agents can be dissolved.

Because acid is metered into at least one relaxation stage, a highly acid slag bath as in DE 41 09 231 C2, at a pH of 4.4, for example, is required. A pH of the slag bath of 5 to 6 is preferred, in order to be able to use less expensive construction materials.

Heating of water that contains calcium is very critical. The water passed into the quench, which is to be heated, consists predominantly of recirculated water that is formed by means of filtration of the suspension. Since calcium is usually a major component of the suspended ash, the water is saturated with calcium in the form of calcium hydrogen carbonate. With an increasing water temperature, the CO₂ solubility decreases, and therefore the water-soluble calcium hydrogen carbonate Ca(HCO₃)₂ is converted to calcium carbonate CaCO₃, which is hardly soluble at all, and is precipitated as a deposit. The consequences of this phenomenon can be observed in water boilers.

In the relaxation involving direct contact of the relaxation vapors with the water to be heated, according to the invention, part of the acidic gases that escape from the relaxed suspension, such as CO₂ and H₂S, is absorbed by the water to be heated, and therefore the equilibrium is shifted in the direction of calcium hydrogen carbonate. In the case of pressure gasification under at least 1 MPa and a CO₂ content in the quenched, moist gas of 1% or more, the precipitation of deposits from the heated water can therefore be reduced.

In order to promote precipitation of these deposit-forming agents later, the pH can be raised again, according to the invention, ahead of the settling basin or the filtration, for example by metering in bases.

In order to accelerate agglomeration in the settling basin, additives are required at a suspension temperature of approximately 60° C. In order to reach such low temperatures by means of evaporation, a partial vacuum of 0.02 MPa is aimed at in the last relaxation stage. The cooling medium must be colder in this stage, something that can be achieved, for example, by means of cooling the recirculated filtrate by mixing in cold water or by means of cooling with fresh water.

Example of an overall design of a relaxation stage:

### Suspension:

Entry 3 wt.-% ash, 100 kg/s, 220° C., 40 bar

Steam pressure in the stage 14 bar→boiling temperature 195° C.
Evaporation enthalpy 1958 kJ/kg
Cooling 220−195=25K Q=100*4.2*25=10500 kW
causes evaporation of 10500/1958=5.4 kg/s H₂O
Steam density 7.1 kg/m³→steam volume 0.76 m³/s

Cooling with filtrate, 100 kg/s
Resulting heating by means of steam condensation by 24K

Flow through bulk material takes place upwards
Condensate density 870 kg/m³→condensate volume 0.12 m³/s
Empty pipe velocity of the condensate in the bulk material 0.04 m/s
Required cross-section 3 m²→D=2 m
Height of bulk material 1 m
Spec. surface area of the bulk material 500 m²/m
Total surface area of the bulk material 3*1*500=1500 m²
Heat entry coefficient 1 kW/m²/K
Resulting average temperature difference 10500/1500/1=7K

The above estimate shows that slight temperature differences between the steam from suspension relaxation and the filtrate to be heated can be achieved despite relatively small dimensions of a relaxation stage.

A cascade of relaxation stages can be managed easily in terms of control technology, since the suspension flow is influenced by means of level regulators, while the steam pressures in the containers of the cascade adjust themselves automatically, as a function of the amounts and temperatures of the suspension, and of the medium to be heated, for example the filtrate.

The invention also provides for treatment of the raw gas taken from the mixing container, which is enriched with steam, for example by passing it to a Venturi scrubber and/or to a droplet precipitator, and/or, as desired, to a multi-stage scrubber and/or conversion devices for carbon monoxide contained in it, and/or to an absorption device for oxygen, for forming the pure gas.

By means of variation of the feed of additional fresh water, it is possible to wash out soluble substances, for example, such as HCl, HF, or the like.

The following conditions according to the invention can be present:
pressure at least 1 MPa, CO₂ content in the quenched, moist gas at least 1% vol.;
part of the gases that escape during relaxation, or CO₂, is absorbed by the heated water;
separation of the solid from the suspension, part of the water low in solids that is obtained is first heated using the palpable heat of the suspension or the condensation heat from the relaxation steam, and then used as quench water;
at least two-stage relaxation.

To accomplish the task defined further above, the invention also provides for a corresponding system or device that is characterized in that a line is provided between the lower region of the mixing container to a first relaxation container, configured as a washing column, whereby the washing column is provided with a condensate collection bottom and a recirculation line to the mixing container, which is equipped with spray heads, for the condensate that occurs, whereby further embodiments of the device are evident from the dependent claims.

In the following, the invention will be explained in greater detail, in an example, using the drawing. This shows, in the single FIGURE, a fundamental representation of the system according to the invention for implementation of the method according to the invention.

The system, which is reproduced in simplified form in the FIGURE, in part, has a gasification reactor 1 that has a reaction chamber 1a into which a fuel 2a that contains carbon and a gas 2b that contains oxygen are fed. Such a gas can also contain carbon dioxide and steam.

Coal gasification takes place in the reaction chamber indicated as 1a. The raw gas obtained in this manner flows into a mixing container 1b that follows the reaction chamber 1a, in which container it is mixed and cooled with circulating suspension, process condensate and/or supplemental water; the related feed lines are indicated with 4a-4b, 10b, and 21e.

The raw gas is first passed through a narrow point at which a free-falling film of water, indicated as 1c, represents the transition from reaction chamber 1a to the mixing container 1b. The slag that collects in the sump of the mixing container is passed out in the direction of gravity, at the bottom at 1d.

In the mixing zone, part of the water evaporates, causing the out-flowing, cooled raw gas 5 to have a high steam content. Since more water is fed into the mixing container than required for evaporation, part of the non-gasified fuel and of the flue ash impacts in the mixing vessel as a suspension, which is eliminated by way of the line 6. In this connection, part of this suspension, as already indicated briefly above, can be recirculated to form the free-falling film of water 1c, if necessary by adding supplemental water (arrow 4a).

For further treatment, this suspension is passed to additional units for cooling and relaxation by way of the line 6, in order to be able to separate the solids from the suspension in the pressure-free state, in cost-advantageous manner. For this purpose, washing columns 7a-7d are shown in the FIGURE, in which part of the water evaporates, rises upward, and is condensed by way of the washing. These washing elements of the washing columns are indicated with 7a-7d. The part of the suspension from the sump of a washing column that is still mixed with water, in each instance, is fed into the next washing column, whereby the washing water that is heated by the treatment can be used, at least in part, in the mixing container 1b. This is indicated with the arrows 10a and 10e, respectively.

As is evident from the circuit, the first washing column receives cooling water from the subsequent washing column (line 10b), while the second washing column receives its cooling water from the third washing column, as reproduced with the line 10c, so that a quadruple cascade is obtained in the FIGURE, whereby in the final analysis, the last washing column receives comparatively cold water from the waste water of a clarification basin 12, which was passed to a water tank 16a by way of a line 13, whereby coolers can be provided, in each instance, as heat exchangers 16b and 16c, respectively, in the recirculation line, on the one hand, and in the application line 11 of the suspension to the clarification basin 12.

By means of the relaxation, part of the gases dissolved in the suspension is also released with the steam. In order to avoid accumulation of the gases in the relaxation chamber, smaller amounts of gas are passed away by way of the head of the columns, as indicated with 9a to 9d.

In order to keep the amount of the gas to be disposed of small, it is practical to condense the steam out to a great extent. For this purpose, a region 9f to which colder water 24b is applied is provided above the washing column 7a, and a cooler 9g is provided above the washing column 7b. The heated washing water of condensate 9i obtained from this second cooling stage can be used either for being mixed with raw gas or for other purposes. A droplet precipitator 9h reduces the amount of the entrained liquid water. The thickened suspension 11 from the last relaxation stage is finally passed into a settling and clarification basin 12. From the clarification basin, the water 13, which is low in solids, is recirculated into the washing columns 7a-7d. In this connection, a device for cooling 16b, as already indicated above, can optionally be used. If necessary, cooling water can also be supplied from the outside and used either separately 4f or mixed with the clarified water 4d.

Preferably, the solids-rich fraction from the settling basin is filtered using a band filter press 14. The precipitated solid 15 leaves the system, while the water, which is low in solids, is recirculated into the settling basin. Not shown are additional tanks for the thickened suspension 12a and for the filtrate 14a, which is low in solids, which allow periodic shut-off of the filter 14. For this purpose, a tank 16a can optionally be used. Part of the water that is low in solids is passed out of the process as waste water 17, in order to limit accumulation of the salts in the water.

Low temperatures, for example <60° C., are advantageous for the separation of solids. In order to achieve such temperatures in the last relaxation stage, not only the cold washing water 4f but also a suction device is required. This can be either a mechanical vacuum pump or a jet device.

The raw gas 5 obtained from the coal gasification is at first mixed with process condensate or wash water 21d in a Venturi washer 19. Subsequently, it is freed of the entrained fine particles and drops of fluid in a droplet precipitator or cyclone 20. Afterwards, it is freed of the solid fine particles and water-soluble contaminants in a washing tower 21. The wash water from the washing tower can be recirculated into the cooling process of the raw gas (arrow 21e), or can be collected and stored in a tank 21f. Here again, supplemental water can be supplied.

Afterwards, the raw gas gets into two devices 22a, 22b, one after the other, for CO conversion. In advantageous manner, a heat exchanger 23 can be switched behind the first converter. To separate the carbon dioxide and the other acidic gases, the gas is then also passed through an absorption tower 25. Purified synthesis gas, fuel gas, or hydrogen 25a, and the entrained acidic gases 25b, are obtained. Behind the second converter, there is a device 24 for cooling and precipitation of the condensate. The condensate 24a that is obtained can be recirculated into the washing tower 21 or partly relaxed and stripped, in order to drive out the dissolved gases. A cost-advantageous alternative for degasification of the condensates is offered by the washing columns, in that the condensate 24b is used for washing 9f.

Of course, the invention is not restricted to the above exemplary embodiment, but rather can be modified in many different respects, without departing from the fundamental idea of the invention.

1-15. (canceled)

16. Method for treatment of fluid streams that occur in the gasification of fuels that contain carbon and ash, whereby during gasification, fuel is reacted, in a reactor, with a gas that contains oxygen, to form a raw gas, the raw gas that results from gasification is mixed with water in a subsequent mixing container and cooled, the evaporated part of the water is passed away out of the mixing container with the raw gas, and the remaining solid/water mixture (suspension) is passed away, at least in part, whereby
the suspension passed out of the mixing container is relaxed in at least one subsequent stage, with evaporation of at least part of the water and a decrease in temperature, and wherein the resulting steam is cooled by means of direct contact with water, and condensed out, at least in part,
wherein
the suspension from one relaxation stage is passed to the subsequent relaxation stage, whereby the condensate of the further relaxation stage is recirculated to the preceding relaxation stage.

17. Method according to claim 16,
wherein
in order to produce a vacuum in the last relaxation stage, cold fresh water is fed in.

18. Method according to claim 16,
wherein
the waste gases that form in the dome of the relaxation stage, in each instance, are suctioned off and passed to further treatment.

19. Method according to claim 16,
wherein
the suspension from the last relaxation stage is passed to a settling basin or the like, for separation of solid and waste water, whereby the resulting waste water is recirculated into a relaxation stage.

20. Method according to claim 16,
wherein
a partial stream of the suspension is recirculated to form a film of water in a transition location between reaction chamber and mixing container.

21. Method according to claim 16,
wherein
the suspension and/or the water to be heated is/are acidified before or in the relaxation stages, for example with hydrochloric acid or acetic acid.

22. Method according to claim 16,
wherein
before introduction into the settling basin and/or before filtration, the pH is adjusted to between 7-9, for example, by means of metering in bases.

23. Method according to claim 16,
wherein
the raw gas from the mixing container is passed to a Venturi scrubber and/or droplet precipitator and/or washing tower and/or conversion devices for carbon monoxide that is contained in it and/or to an absorption device for oxygen, to form the pure gas.

24. Device for implementing the method according to claim 16, with a gasification reactor (1) having a mixing container (1b) for mixing the raw gas that occurs during gasification with water, whereby a line (6) is provided between the lower region of the mixing container (1b), to a first relaxation container configured as a washing column (7a), whereby the washing column is provided with a condensate collection bottom (8a) and a recirculation line (10a) to the mixing container (1b), equipped with spray heads, for the resulting condensate,
wherein
a plurality of washing columns (7a-7d) or comparable relaxation devices are provided, one behind the other, with connection lines of the sumps (8a-8d), in each instance, for the suspension, and condensate recirculation lines (10a-10d) from the subsequent washing column to the preceding washing column and/or to the mixing container.

25. Device according to claim 24,
wherein
installation for the formation of a film of water (1c) are provided in the transition region between reaction chamber and mixing container.

26. Device according to claim 24,
wherein
a raw gas line (5) that leads from the head region of the mixing container is provided, for application to a Venturi scrubber (19) and/or a droplet precipitator (20) and/or a washing tower (21), with application and recirculation lines for process condensate and/or wash water and/or fresh water.

27. Device according to claim 24,
wherein
a settling or clarification basin (12) or the like is provided behind the last washing column (7d), for application of the suspension, with water removal (17) and solids removal (15).
